(19) United States
(12) Patent Application Publication
(10) Pub. No.: US 2002/0158602 A1
(43) Pub. Date: Oct. 31, 2002

(54) Combination travel and protection bag with photovoltaic battery charger

(76) Inventor: Neil A. McNair JR., Clifton, NJ (US)

Correspondence Address: Neil A. McNair Jr., P.O. Box 42, Ramsey, NJ, 07446-0042, US

(21) Appl. No.: 09/845,023

(22) Filed: Apr. 28, 2001

(51) Int. Cl. H02J 7/00

(52) U.S. Cl. 320/107

(57) ABSTRACT

Combination traveling and protective bag with photovoltaic battery cells for handheld video game systems or electrical devices. The traveling bag comprises photo voltaic cells colligate into the travel bag for recharging an extra set of replacement battery cells. Special pivoting mounts of the photo voltaic cells would allow for minute adjusting achieving the best angle toward the light source. Convenient perforations allow an end user to access the hand held video game system or electrical device viewing screen, operation and command buttons while the travel bag is being used. The travel bag also comprises one or more clips for using a shoulder or holding strap. When the batteries are recharged a special sound would alert the user. Removable sections on the travel bag can allow the end user to change and upgrade the photo voltaic cells and thus permitting the travel bag to evolve with the power needs of the end user.

### FIELD OF INVENTION

This invention relates generally to travel and carry bags and the use of photo voltaic cells as a power source and charger, and more particularly to travel bags for hand held video game systems and electronics that use A, AA. AAA, C, D and lithium battery cells as a power source.

### DESCRIPTION OF THE PRIOR ART

Most battery chargers allow the battery pack to be slid into place in a charger in a manner that permits the batteries to be charged while still attached to the device on which it is normally used. These chargers also include a conventional flexible power cord with a plug at one for attaching the charger to a power source, such as a conventional AC connector, either in a wall or at the end of an extension cord. Thus the travel pack or bag is separate from the charger. Travel bags and packs for the chargers themselves are separate with the travel bag or case just holding the charger. In these examples the chargers are to be REMOVED from the travel case when used and is not integrated into one unit.

U.S. Pat. No. 5,780,993 Tsang, requires a mechanical connector and is not colligated as part of a protective cover or travel bag. U.S. Pat. No. 5,780,993 Tsang in his “field of Invention” and “CLAIMS” states “when the battery pack is mechanically attached to the device having a mechanical connector adapted to engage the mechanical connector of the battery pack for attaching the battery pack to the charger”. In addition U.S. Pat. No. 5,780,993 Tsang attaches directly to the battery pack Thus U.S. Pat. No. 5,780,993 Tsang is not intended to serve as a travel or protective bag. Nor does Tsang U.S. Pat. No. 5,780,993 feature any “convenience perforations” which allows the “end-user” to access the hand held video game unit's screen and command buttons and through the travel bag.

Carry cases and bags for hand held video game systems are made by various manufactures yet they lack any photo voltaic power cells colligated to the case or bag. They also lack a bay for storing and charging an extra set of battery cells while those cells are being charged.

### SUMMARY OF THE INVENTION

It is the objective of this invention to provide a lightweight travel bag for hand held video game system that combines photo voltaic cells colligated to the travel bag's skin covering for recharging an extra set of A, AA, AAA, C or D battery cells. The travel bag would fit snug onto or over the hand held video game system in whole or partially and include convenience perforations whereby allowing the end user to access the video game system's screen and command buttons. The materials used to construct the travel bag can be natural or man-made and include everything from leather and vinyl to wood and plastic. Because the travel bag would also serve as a secondary outer protective skin with the video game system fitting snuggly through an aperture in the bag it would need to be of a stylish design and coloring and would feature one or more clips for attaching a hand or shoulder carry straps. Special flexible coupling mounts for the photo voltaic cells colligated to the travel bag would allow for the cells to be tilted toward the light source. When the battery cells in the hand held video game unit expire the end user places them into the travel bags charge bay, which is also colligated to the travel bag. When charging is complete sounds from the travel bag's sound producing elements, which could be music, chirping or voice would notify the end user.

In accordance with still another aspect of the invention the travel bag would include special removable panels that hold the photo voltaic cells. This removable panel would attach to the travel bag using a variety of engaging methods that would permit the end user to replace the photo voltaic cells with more powerful photo voltaic cell colligated to another panel. Thus permitting the end user to adapt the travel bag according to his or her need.

### DRAWING FIGURES

Reference is now made to the following descriptions taken in conjunction with the accompanying drawings in which:

FIG. 1. Shows an aspect to the travel and protection bag with the mountable gib panel section still attached.

FIG. 2. Shows the mountable gib panel separated from the travel and protection bag by way of a zipper.

### REFERENCE NUMERALS IN DRAWINGS

3 Support means

4 Aperture

5 Convenient perforations

6 Demountable Gib panel

7 Photo Voltaic Cell

8 Flexible coupling member

9 Battery Charge chamber

10 Sound emitting element

11 Zipper

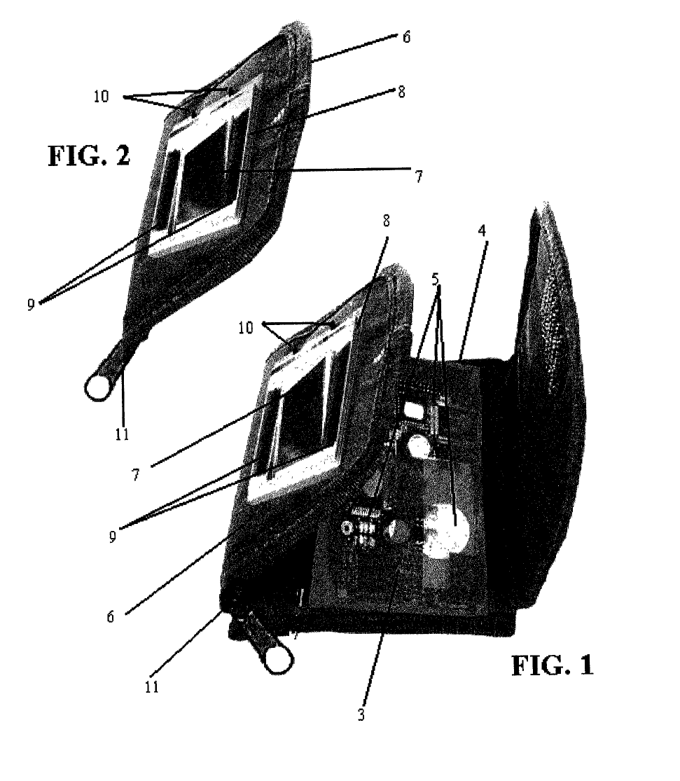

### DESCRIPTIONS FIGS. 1 AND 2—PREFERRED EMBODIMENT

A preferred embodiment of the Travel and Protection bag is illustrated in FIG. 1 and FIG. 2.

FIG. 1. Shows a typical hand held video game system that is being held in the travel bag by the support means 3 after being inserted through the aperture 4. Convenient perforations 5 allow the end user access to the video game system's screen and command buttons. Attached to the travel bag in FIG. 1 is the mountable gib panel 6, which is mounted to the travel bag by way of a zipper 11. Typically the mountable gib panel is constructed of the same material as the travel bag, which could range from a sturdy vinyl, leather or plastic to wood. The mountable gib panel also features a flexible coupling member 8 colligated to it. This flexible coupling member 8 would allow the photo voltaic cell 7 to be pivoted toward any light source to achieve maximum performance. Also colligated to the mountable gib panel 6 is a battery charge chamber 9. Typical A, AA, AAA, B, C, and D size battery cells are charged here from power supplied by the photo voltaic cell 7. Once charging is complete sound-producing elements 10 would alert the end user of the battery status.

FIG. 2. Show the demountable gib panel 6 removed from the travel and protection bag via a zipper 11. With this embodiment the gib panel 6 can be replaced with another gib panel that features a more powerful photo voltaic cell 7, more varied sound producing elements 10 or a battery charge chamber 9 that can accept and charge batteries of a different size.

Alternative Embodiments.

There are various possibilities with regards to the Travel bag. One such embodiment would not allow removal of the gib panel. Instead the end user would upgrade each of the features, photo voltaic cell, sound producing element and battery charge chamber individually. Another embodiment would feature a non-removable photo voltaic cell.

Advantages

From the descriptions above, a number of advantages of this Travel and protection bag become evident.

A snug and lightweight travel bag and reliable source of battery charge power all in one for the traveling public.

Batteries can be charged throughout the day without the need of an AC OUTLET. And be there when needed during the travel time.

The travel case photovoltaic charge power and battery cell chamber can be upgraded to meet the evolving needs of the consumer.

When the Travel case completes charging, an indicator sound notifies the user.

Energy efficient for consumers living in energy strap regions.

Conclusion and Scope

Most electronic require bulky and cumbersome battery chargers to be carried in a separate case. These chargers also in most cases require an AC outlet. The traveling public will appreciate a travel bag that combines the mobility of a lightweight hand- bag with efficient photovoltaic charge power for their battery cells, while allowing the user to operate their video game system or electronic device at the same time through the travel bag's convenient perforations. When the battery charge needs of the consumer grow this travel bag can evolve to meet those new needs with upgradeable gib panels. Flexible mounting of the photovoltaic cells allow the user to tilt the cells to maximize the available light source. When charging is complete a sound alerts the user that his batteries are ready for use.

Thus it can be seen that this Combination travel and protection bag with photovoltaic cells takes the prior art and advances and adapts it to the needs of the modern traveling public.

Thus the scope of this invention should be determined by the appended claims and their legal equivalents, rather then by the examples given.

What is claimed is:

1. A Combination travel and protection bag with photovoltaic battery charger for hand held video game systems being powered by A, AA, AAA, B, C, and D size battery power cells, said travel bag being adapted to receive an hand held video game system comprising:
A. Support means comprising an aperture of an predetermined girth whereby said travel bag can accept and hold said hand held video game system
B. convenient perforation means whereby allowing the end user access to said video game system's viewing screen and command buttons through the said travel bag
C. at least one photo voltaic cell colligated to the travel bag
D. at least one battery charge chamber colligated to the travel bag whereby battery cells can be charged.

2. The combination travel and protection bag with photovoltaic battery charger of claim 1 further comprising an flexible coupling member thereby allowing nutate movement of the said photo voltaic cells so that the said photo voltaic cell can be realigned to help achieve optimum performance.

3. The combination travel and protection bag with photovoltaic battery charger of claim 1 further comprising an demountably gib panel means whereby the photo voltaic cell can be upgraded so that said travel bag can be adapted to the evolving needs of the end user.

4. The combination travel and protection bag with photovoltaic battery charger of claim 1 further comprising sound emitting elements whereby the said travel bag could audibly notify the end user when recharging is complete.

5. A combination travel and protection bag with photovoltaic battery charger for hand held video game systems, said travel and protection bag being adapted to receive a hand held video game system comprising:
A. Support mean comprising an aperture of an predetermine girth
B. Convenient perforation means whereby the end user can access the said hand held video game screen and command buttons
C. at least one photo voltaic cell colligated to the travel bag
D. at least one battery charge chamber colligated to the travel bag
E. at least one sound emitting element whereby said travel bag could audibly notify the end user when charging is complete.

6. The combination travel and protection bag of claim 5 further comprising an flexible coupling member for mounting said photo voltaic cell whereby said photo voltaic cell could be realigned for optimum performance.

7. The combination travel and protection bag of claim 5 further comprising an detachably gib panel means whereby allowing the photo voltaic cells to be upgraded.

8. A combination travel and protection bag of with photovoltaic battery charger for hand held electronic equipment, said travel and protection bag being adapted to receive hand held electronic equipment comprising:
A. Support means comprising an aperture of an predetermine girth whereby said travel and protection bag can accept and hold said electronic equipment
B. convenient perforation means whereby the end user can access the said electric equipment command buttons
C. at least one photo voltaic cell colligated to the travel bag
D. at least one battery charge chamber colligated to the travel bag.

9. The combination travel bag of claim 8 further comprising an flexible coupling member means for mounting said photo voltaic cells whereby said photo voltaic cells can be realigned for optimum performance.

10. The combination travel and protection bag of claim 8 further comprising sound emitting elements whereby said travel bag could audibly notify the end user when charging is complete.
